(19) United States
(12) Patent Application Publication
(10) Pub. No.: US 2022/0036358 A1
(43) Pub. Date: Feb. 3, 2022

(54) DIGITAL CURRENCY SETTLEMENT SYSTEM AND SETTLEMENT METHOD AND PAYMENT DEVICE

(71) Applicants: Beijing Bigcode Technology Co., Ltd., Beijing (CN); Beijing Sigone Investment Co., Ltd., Beijing (CN)

(72) Inventors: Wei SHEN, Beijing (CN); Liduo ZHONG, Beijing (CN)

(21) Appl. No.: 17/256,605

(22) PCT Filed: Sep. 17, 2018
(86) PCT No.: PCT/CN2018/106050

§ 371 Date: Dec. 28, 2020

(30) Foreign Application Priority Data
Jun. 28, 2018 (CN) 201810693150.3

(51) Int. Cl. G06Q 20/40; G06Q 20/32

(52) U.S. Cl. CPC G06Q 20/4014; G06Q 20/3274; G06Q 2220/00; G06Q 20/3278; G06Q 20/4015

(57) ABSTRACT

A digital currency settlement system, includes: a payment device, a digital currency block chain system, a network server, a management center, and a settlement terminal. The settlement terminal reads user information in the payment device of User A to generate a transaction, and the transaction is transmitted to the management center through the network server. The management center converts the quantity y of a digital currency in the transaction information into an intermediate currency of a corresponding quantity Y0, and transfers the intermediate currency of the corresponding quantity Y0 from an account of User A to an account of User B, and after a certain time, the total quantity Y of the intermediate currency in the account of User B is counted and converted into the digital currency of a corresponding quantity Z according to the total quantity of the intermediate currency.

### CROSS-REFERENCE TO RELATED APPLICATIONS

This application is a national stage application of PCT/CN2018/106050. This application claims priorities from PCT Application No. PCT/CN2018/106050, filed Sep. 17, 2018, and from the Chinese patent application 201810693150.3 filed Jun. 28, 2018, the content of which is incorporated herein in the entirety by reference.

### FIELD

The invention relates to a digital currency settlement system, a settlement method and a payment device using block chain technology, in particular relates to a technology for reducing and shortening the cost and time spent on block chain verification in the digital currency settlement process.

### BACKGROUND

Block chain technology, also known as distributed ledger technology, is characterized by decentralization. Due to the use of distributed accounting and storage, the data blocks in the system are jointly maintained by the nodes with maintenance function in the whole system, and there is no centralized hardware and management mechanism, which not only makes the information highly transparent, but also eliminates human intervention, greatly improving the stability and reliability of data. In recent years, block chain technology has developed rapidly and has been widely used in digital currency, assets certification, evidence preservation and other fields.

Literature 1 (Publication No. JP 2018-28762) discloses a technology for payment by using block chain technology. As shown in FIG. 16, the user terminal 21 and the merchant terminal 22 are respectively connected to the block chain system 20 through the network NW, and the voucher management system 10 manages vouchers in the block chain system 20 through the network NW. When using vouchers for payment, the user terminal 21 sends an instruction for using the vouchers to the block chain system 20 through the network NW, and the block chain system 20 sends a confirmation instruction to the voucher management system 10 according to the instruction. After confirming that the merchant can use vouchers, the voucher management system 10 notifies the block chain system 20 to generate a transaction for voucher movement.

Literature 2 (Publication No. JP 2017-204070) discloses a technology for using block chain technology to manage the use license of video works and using digital currency for payment.

FIG. 17 is a system diagram of using block chain technology to manage the use license of video works and using digital currency for payment. As shown in FIG. 17, the system includes a playback device (user device) 1, a media management block chain BC2, a management device (right owner device) 2, and a virtual currency block chain BC1. When using a video works, the user operates the playback device 1 to send an application to the media management block chain BC2. The application, as a transaction, includes the hash address for payment and the information of the program to be played. After confirming the transaction, the media management block chain BC2 sends a licensing request to the management device 2. After licensing by the management device 2, a transaction is generated based on the hash address. The transaction is connected to the end of the block chain in the form of blocks after being broadcast on the virtual currency block chain BC1. The playback device 1 can play the video work because it is licensed.

In the Literatures 1 and 2, due to the need of data synchronization and independent verification of transactions by different nodes in the transaction process, the more transactions, the higher the verification cost and the increased expenditure for verification. Especially for daily shopping, a large amount of small amount and multiple times of payment will generate considerable commission charges, which will directly affect users' enthusiasm to use digital currency for payment.

In addition, it takes a long time to generate blocks in the block chain. For Bitcoin, it takes about 10 minutes to complete the transaction. This kind of transaction time consumption also brings a bad user experience and affects the user's enthusiasm.

During the transaction, the user terminal 21 and the voucher management system 10, the playback device (user device) 1 and the management device (right holder device) 2 need to be online, that is, they need to be connected to the block chain system 20 and the virtual currency block chain BC1. Therefore, payment with vouchers or virtual goods must depend on the network, that is, it cannot be used offline, which also limits the application of digital currency in the block chain.

Literature 3 (Publication No. JP 2018-77641) discloses a settlement system. When a bank debit card is used for settlement (make a payment or transfer), once the user confirms the settlement, the bank settlement system immediately executes the transfer operation according to the user's request. Even if the user makes an error operation, there is no chance to correct it, and the security of transfer cannot be fully guaranteed.

To solve this problem, as shown in FIG. 18, Literature 3 provides a temporary settlement server 300 between the bank server 200 and the EC terminal 100. When user A operates the EC terminal 100 to transfer money to user X's bank account, the bank server 200 transfers money from user A's bank account to a public account P according to the transfer request, and the temporary settlement server 300 transfers a corresponding amount of virtual money from user A's virtual money account to user X's virtual money account through an intermediary account M. At this time, the money transferred from user A's bank account does not enter user X's bank account, that is, the transfer has not been completed, and user A can notify the bank at any time to request the suspension of the transfer to user X's bank account X.

After a certain period of time, the temporary settlement server 300 notifies the bank server 200 to move the money of the user A from the public account P to the user B′ bank account X, thus completing the money transfer from the bank account A of the user A to the bank account X of user X.

However, in essence, the settlement system of the Literature 3 only makes the money transfer between accounts immediately lag behind for a period of time, leaving time for users to turn back. Therefore, it does not solve the problems of high payment cost and excessive transaction time when using digital currency to make payments.

The first purpose of the present invention is to solve the problems of high cost and long time spent in verifying transactions in the block chain system when paying with digital currency.

The second purpose is to solve the problem that users can't pay with digital currency when there is no network, and realize the payment without network (offline payment).

### SUMMARY

The first technical solution is a digital currency settlement system, which is characterized by including a payment device 1, a digital currency block chain system 3, a network server 4, a management center 5, and a settlement terminal 6, wherein the management center 5 is respectively connected with the network server 2 and the digital currency block chain system 3, the settlement terminal 6 is connected to the management center 5 through the network server 2, and there are also nodes 1 . . . n connected that can confirm transactions in the digital currency block chain system 3 in addition to user B and the management center 5,

the payment device 1 is used for paying digital currency to other users, and the payment device 1 at least stores account addresses of the users in the digital currency block chain 3,

when the user A pays or transfers the digital currency to the user B by using the payment device 1,

the settlement terminal 6 reads at least an account address of user A in the digital currency block chain 3 from the payment device 1, and generates a transaction after identifying the information, the transaction is sent to the management center 5 through the network server 2, and the transaction information includes the account address of the user A in the digital currency block chain read by the payment device 1, an account address of the user B who receives a payment in the digital currency block chain, and the amount y of digital currency moved from the account address of the user A in the digital currency block chain to the account address of the user B in the digital currency block chain.

the management center 5 stores at least the account addresses of the user A and the user B, and an account address of the management center 5 in the block chain, wherein accounts of the user A and the user B are used for transferring the intermediate currency, and a certain amount of intermediate currency is pre-stored in the account of the user A, the management center 5 converts the amount y of digital currency in the transaction information into a corresponding amount Y0 of the intermediate currency according to the received transaction, and moves the corresponding amount Y0 of the intermediate currency from the account of the user A to the account of the user B, after a certain time or after the intermediate currency transferred to the account of the user B reaches a certain amount, the management center 5 counts a total amount Y of the intermediate currency in the account of the user B, converts the total amount Y of the intermediate currency into a corresponding amount Z of digital currency, and sends the transaction information to the digital currency block chain 3, and records the transaction information as a block at an end of the block chain and after confirmation by the nodes 1 . . . n, the transaction information includes the account address of the management center 5 in the block chain, the account address of the user B in the block chain, and the amount Z of digital currency moved from the account address of the management center 5 to the account address of the user B in the block chain; after the digital currency is successfully moved, the management center 5 subtracts a corresponding amount of the intermediate currency from the account of the user B.

The second technical solution is based on the first technical solution, and is characterized by further including a user terminal 11,

wherein the user terminal 11 generates the transaction and moves the digital currency to the account address of the management center 5 in the block chain before the user A uses the payment device 1 to pay the digital currency to other users;

The transaction information includes the account address of user A in the block chain, the account address of management center 5 in the block chain, and the amount x of digital currency moved from the account address of user A to the account address of management center 5 in the block chain;

According to the received the transaction information, the management center 5 converts the amount x of digital currency in the transaction information into corresponding amount X0 of the intermediate currency, and records the corresponding amount X0 of the intermediate currency in the account of the user A to recharge the payment device 1 of the user A.

A third technical solution is based on the second technical solution, and is characterized in that,

the user A includes more than one user who move the digital currency to the account address of the user B in the digital currency block chain, and each of the user A has a different account address in the digital currency block chain.

The fourth technical solution is based on the third technical solution, and is characterized in that,

the management center 5 judges whether an amount X of the intermediate currency in the account of the user A is greater than or equal to the corresponding amount Y0 when the corresponding amount Y0 of the intermediate currency is moved from the account of the user A to the account of the user B, when the amount X of the intermediate currency in the account of the user A is greater than or equal to the corresponding amount Y0, the corresponding amount Y0 of the intermediate currency is moved from the account of the user A to the account of the user B.

The fifth technical solution is based on the third technical solution, and is characterized in that,

the management center 5 judges whether the amount X+m of intermediate currency in account of user A is greater than or equal to the corresponding amount Y0 when the corresponding amount Y0 is moved from account of user A to account of user B, when the amount X+m of the intermediate currency in the account of user A is greater than or equal to the corresponding amount Y0, Y0 amount of the intermediate currency is moved from the account of user A to the account of user B, where m is the overdraft amount of the intermediate currency.

The sixth technical solution is based on the fifth technical solution, and is characterized in that,

the user terminal 11 includes an input module 110, a transaction generation module 111, a block chain account address storage module 112, and a communication module 114,

the block chain account address storage module 112 at least stores the account address of the user in the block chain and the account address of the management center 5 in the block chain,

the input module 110 is used for inputting an amount of digital currency moved to the account address of the management center 5, and the block chain account address storage module 112 selects the account address of the user and the account address of the management center 5 in the block chain.

the transaction generating module 111 generates a transaction, and the transaction information includes the amount of digital currency input by the user and the information that the amount of digital currency is moved from the account address of the user in the block chain to the account address of the management center 5 in the block chain.

The seventh technical solution is based on the sixth technical solution, and is characterized in that the settlement terminal 6 includes an information reading module 61, a transaction generating module 62, an account address storage module 63, a display module 64, and a communication module 65,

the information reading module 61 has the functions of reading the account address of the user in the block chain from the payment device 1 and inputting or reading the amount information of digital currency paid by the user; the account address storage module 63 stores at least the account address of user B receiving payment in the block chain; the transaction generation module 62 generates a transaction, and the transaction information includes the read account address of user A in the block chain, the account address of user B receiving payment in the block chain, and the amount of digital currency moved from the read account address of user A in the block chain to the account address of user B receiving payment in the block chain.

The eighth technical solution is based on the seventh technical solution, and is characterized in that the management center 5 includes a communication module 51, an information analysis module 52, a conversion module 53, an account storage module 54, an account address storage module 55, a digital currency movement control module 56, and a counting module 57,

the communication module 51 is used for communicating with the network server 4 and the digital currency block chain 3, receiving the transactions sent by the settlement terminal 6, and sending the transactions to the digital currency block chain 3,

the account storage module 54 stores accounts of users including user A and user B,

the conversion module 53 performs conversion between digital currency and intermediate currency,

the account address storage module 55 stores the account addresses of each user including user B in the block chain and the account addresses of the management center 5 in the block chain, the account of each user is associated with the account address in the block chain,

the statistics module 57 counts the amount of intermediate currency in the account of the user,

the digital currency movement control module 56 controls the statistics module 57 to count the total amount y of the intermediate currency in the account of the user B who receives the intermediate currency, and the counting result is converted into the amount Z of digital currency by the conversion module 53 and then input to the transaction generation module 58.

the transaction generation module 58 reads the account address of the user B in the block chain and the account address of management center 5 in the block chain from the account address storage module 55 to generate transactions, the transaction information includes the account address of the user B in the block chain and the account address of management center 5 in the block chain, the amount Z of digital currency is moved from the account address of the management center 5 in the block chain to the account address of the user B in the block chain, after the digital currency is moved to the account of the user B, the corresponding amount of intermediate currency is subtracted from the account of the user B.

The ninth technical solution is based on any one of the first to eighth technical solutions, and is characterized in that the payment device 1 is in the form of a card, and a two-dimensional code is printed on the surface of a card 11, and at least the account address of the user in the block chain is encoded into the two-dimensional code.

A tenth technical solution is based on any one of the first to eighth technical solutions, and is characterized in that the payment device 1 consists of a smart phone 11, and the account address of the user is displayed on a screen of the smart phone 11 in the form of a two-dimensional code.

An eleventh technical solution is based on any one of the first to eighth technical solutions, and is characterized in that the intermediate currency and the digital currency are the same digital currency.

The twelfth technical solution is based on any one of the first to eighth technical solutions, and is characterized in that the intermediate currency is any real currency in circulation, and a conversion rate between the digital currency and the intermediate currency is an actual exchange rate at that time.

A thirteenth technical solution is based on any one of the first to eighth technical solutions, wherein the network server 4 stores relevant information associated with user information S, and generates matching information according to the user information S,

the payment device 1 stores at least two fields of information, wherein a first field information includes the account address D1 of the user A in the digital currency block chain 3, a second field information includes the user information S,

the settlement terminal 6 obtains at least two fields of information from the payment device 1, decomposes the information to obtain the first field information and the second field information,

and sends the user information S in the second field to the network server 4, obtains the matching information sent by the network server 4, verifies user identity based on the matching information, and generates the transaction for the user who has passed identity verification.

The fourteenth technical solution is based on the thirteenth technical solution, and is characterized in that the matching information of the network server 4 includes a password,

the settlement terminal 6 judges whether the password input by the user is correct according to the password in the matching information to verify the user identity.

The fifteenth technical solution is based on the thirteenth technical solution, and is characterized in that the matching information of the network server 4 includes a mobile phone number,

the settlement terminal 6 sends a verification code to the mobile phone number according to the mobile phone number in the matching information, and judges whether the verification code input by the user is correct to verify the user identity.

A sixteenth technical solution is based on the thirteenth technical solution, wherein the matching information of the network server 4 includes time or/and position information,

the settlement terminal 6 verifies whether the transaction is carried out at a specified time or/and a specified position according to the time or/and position of the matching information and the current time, or/and the current position of the payment device 1.

The seventeenth technical solution is based on the eleventh technical solution, and is characterized in that the first field includes website information, and the account address D1 of the user A is included in the website information.

The eighteenth technical solution is based on the eleventh technical solution, and is characterized in that,

the second field includes website information, and the user information S is included in the website information.

A nineteenth technical solution is based on the thirteenth technical solution, and is characterized in that the second field information is encoded or encrypted information.

The twentieth technical solution is based on the thirteenth technical solution, and is characterized in that the second field includes control information requiring password input.

The twenty-first technical solution is a digital currency settlement method, which is characterized by including the following steps:

reading step: the settlement terminal 6 reads at least the account address of user A in the digital currency block chain 3 from the payment device 1,

information identifying and transaction generation step: the settlement terminal 6 reads the read information and generates a transaction according to the read information, and the transaction is sent to the management center 5 through the network server 2, and the transaction information includes the account address of the user A in the digital currency block chain read from the payment device 1, an account address of the user B who receives a payment in the digital currency block chain, and an amount y of digital currency moved from the account address of the user A in the digital currency block chain to the account address of the user B in the digital currency block chain,

intermediate currency conversion step: the management center 5 stores at least the accounts of user A and user B and the account addresses of the management center 5 in the block chain, wherein the accounts of the user A and the user B are used for transferring the intermediate currency, and a certain amount of intermediate currency is pre-stored in the account of the user A, the management center 5 converts the amount y of digital currency in the transaction information into a corresponding amount Y0 of the intermediate currency according to the received transaction,

intermediate currency moving step: the management center 5 moves the intermediate currency corresponding to the amount Y0 from the account of the user A to the account of the user B.

counting step: the management center 5 counts the total amount Y of intermediate currency in the account of the user B after a certain time or after the intermediate currency transferred to the account of the user B reach a certain amount.

digital currency conversion step: the management center 5 converts digital currency with a corresponding amount Z according to the total amount of the intermediate currency,

transaction generating and sending step: the management center 5 generates a transaction for moving digital currency to the user B, sends the transaction to the digital currency block chain 3, and records the transaction as a block at the end of the block chain after confirmation by the nodes 1 . . . n, the transaction information includes the account address of the management center 5 in the block chain, the account address of the user B in the block chain, and the amount Z of digital currency moved from the account address of the management center 5 in the block chain to the account address of the user B in the block chain.

account processing step: after the management center 5 successfully moves the digital currency, the management center 5 subtracts the corresponding amount of intermediate currency from the account of the user B.

The twenty-second technical solution is based on the twenty-first technical solution, and is characterized in that,

the network server 4 stores relevant information associated with the user information S, and generates matching information according to the user information S,

the payment device 1 stores at least two fields of information, wherein a first field information includes the account address D1 of the user A in the digital currency block chain 3, a second field information includes the user information S,

in the information identifying and transaction generation step, before generating the transaction, the identified second field information is sent to the network server 4, the network server 4 generates matching information, verifies user identity according to the matching information, and generates a transaction for the user who passes identity verification.

The twenty-third technical solution is based on the twenty-first technical solution, and is characterized in that the matching information sent by the network server 4 includes a password,

In the information identifying and transaction generation step, whether the password in the matching information is consistent with the password input by the user is verified to judge whether the user is the user A.

The twenty-fourth technical solution is based on the twenty-first technical solution, and is characterized in that the matching information sent by the network server 4 includes a mobile phone number,

In the information identifying transaction generation step, a verification code is sent to the mobile phone number, and whether the verification code input by the user is consistent with the sent verification code is verified to judge whether the user is the user A.

The twenty-fifth technical solution is based on any one of the twenty-second to twenty-fourth technical solutions, and is characterized in that the matching information sent by the network server 4 includes time or/and position information,

in the information identifying and transaction generation step, according to the time in the matching information and the current time, whether the transaction time is within a specified time interval or/and the transaction position is within the specified position is verified.

The twenty-sixth technical solution is a payment device in digital currency, which is characterized in that the payment device 1 includes an information carrier 11 and payment information 12 stored on the information carrier, the payment information includes at least two fields of information, wherein a first field information includes an account address D1 of user A in a digital currency block chain 3, and a second field information includes user information S, the user information S is subordinate to the account address D1, and is used for verifying the user.

The twenty-seventh technical solution is based on the twenty-sixth technical solution, and is characterized in that the payment information 12 is printed or displayed on the information carrier in the form of a graphic code, and the graphic code includes at least a QR code or a bar code, which is read by an optical identifying device.

The twenty-eighth technical solution is based on the twenty-sixth technical solution, and is characterized in that the information carrier 11 is a memory chip, and the payment information 12 is stored on the memory chip, the memory chip includes at least any one of NFC chip, RFID chip, SIM card and SD card, and is read by near field or being directly inserted into a card reader.

The twenty-ninth technical solution is based on the twenty-sixth technical solution, and is characterized in that the payment device 1 includes a storage module 13, a payment information generating module 14, and a display module 16, the storage module 13 stores a key and the user information S, and the payment information generating module 14 generates the account address D1 by using the key, and generates the first field information including the account address D1 and the second field information including the user information S, and the display module 16 displays and updates the payment information in the form of a graphic code or electronic signal.

### BRIEF DESCRIPTION OF THE DRAWINGS

FIG. 1 is a block diagram of the overall structure of digital currency settlement system;

FIG. 2 is a structural block diagram of a user terminal;

FIG. 3 is a structural block diagram of a settlement terminal;

FIG. 4 is a structural block diagram of a management center;

FIG. 5 is an explanatory diagram of recharging a payment device from a user terminal;

FIG. 6 is an explanatory diagram of digital currency movement (transfer) when using a payment device for payment;

FIG. 7 is a flow chart of recharging a payment device from a user terminal;

FIG. 8 is a flow chart of digital currency movement (transfer) when using a payment device for payment;

FIG. 9 is a structural block diagram of a digital currency settlement system according to another embodiment;

FIG. 10 is an explanatory diagram of a specific embodiment of a payment device (payment card);

FIG. 11 is an enlarged view of a two-dimensional code encoded with a hash address;

FIG. 12 is an explanatory diagram of another specific embodiment of the payment device;

FIG. 13 is a flow chart of a digital currency settlement method according to a varied example;

FIG. 14 is a structural diagram of a payment device according to a varied example;

FIG. 15 is an explanatory diagram for displaying a hash address by a smartphone;

FIG. 16 is an explanatory diagram of Literature 1;

FIG. 17 is an explanatory diagram of Literature 2;

FIG. 18 is an explanatory diagram of Literature 3.

### DETAILED DESCRIPTION OF EMBODIMENTS

Hereinafter, embodiments of the present disclosure will be illustrated. In the following embodiments, only preferred implementation manners and embodiments are exemplarily illustrated, which should not be construed as limitations to the scope of the present disclosure.

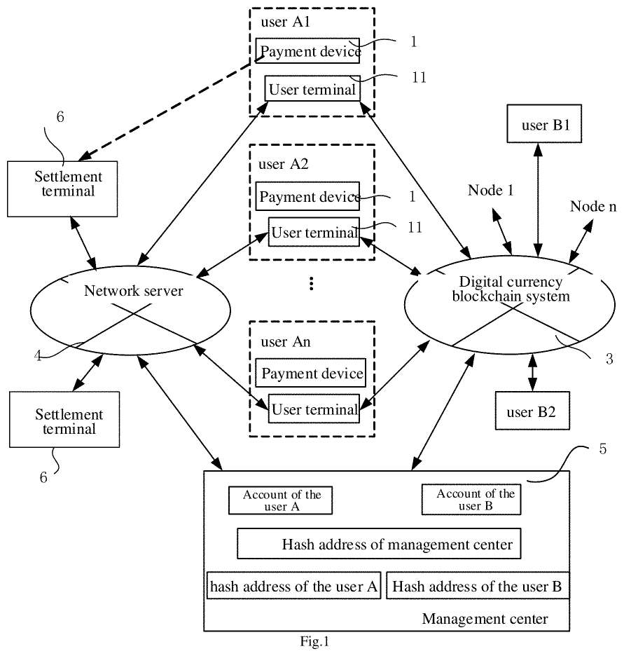

FIG. 1 is a block diagram of the overall structure of digital currency settlement system.

As shown in FIG. 1, the digital currency settlement system according to the present invention consists of a payment device 1, a user terminal 11, a digital currency block chain system 3, a network server 4, a management center 5, and a settlement terminal 6. When shopping, user A pays with his own payment device 1. The currency of payment is digital currency, and the transaction is recorded in the block chain. In addition to payment during shopping, user A can also move the digital currency to hash address of the user B in the block chain through payment device 1.

Unlike the existing digital currency settlement system that directly moves digital currency in the block chain, with the digital currency settlement system according to the present invention, the user uses terminal 11 to move the digital currency to the hash address (account address) of the management center 5 before using the payment device, so as to recharge the payment device 1.

In FIG. 1, each of the user A (A1 . . . An) has a payment device 1 and a user terminal 11. However, the user terminal 11 is optional, alternatively, a user can use another's user terminal 11 instead of his own to move the digital currency to the hash address (account address) of the management center 5 to recharge his own payment devices. The payment object of the user A is not limited to user B (B1, B2), for example, user A1 may pay user A2 or move digital currency to user A2's hash address.

The user terminal 11 and the management center 5 are respectively connected with the network server 2 and the digital currency block chain system 3. The settlement terminal 6 is connected to the management center 5 through the network server 2.

In the digital currency block chain system 3, besides the user terminal 11 and the management center 5, the user B and the nodes 1 . . . n that can confirm the transaction are also connected.

In this embodiment, the digital currency is Bitcoin, and the digital currency block chain system is the Bitcoin block chain system.

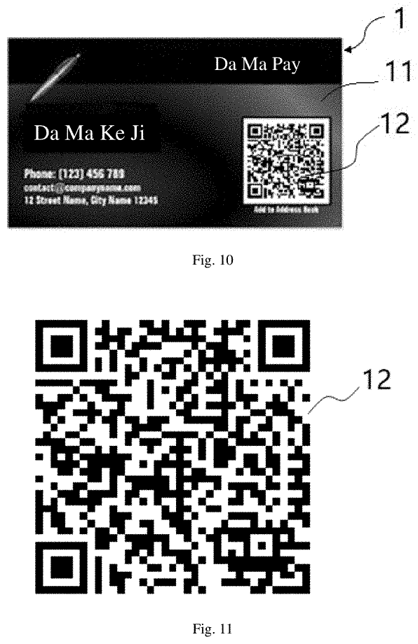

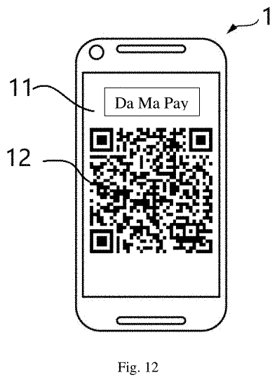

The payment device 1 stores at least the hash address of the user A in the digital currency block chain (the account address of the user in the block chain). FIG. 10 is an explanatory diagram of a specific embodiment of a payment device. In FIG. 10, the payment device 1 takes the form of a card, and a two-dimensional code (QR code) is printed on the surface of the card 11. And at least the hash address of the user A in the block chain is encoded into the two-dimensional code. FIGS. 12 and 15 show another specific embodiment of the payment device. In FIGS. 12 and 15, the smart phone 11 is used as the payment device 1, and the hash address of the user is displayed on the screen of the smart phone in the form of a two-dimensional code (such as QR code). In the two-dimensional codes in FIGS. 10, 12 and 15, besides the hash address of the user A in the digital currency block chain, information for verification is also encoded to prevent the payment device 1 from abnormal use, such as embezzlement. Techniques for preventing abnormal use of the payment device 1 will be described in detail later.

The hash address is not limited to being encoded into two-dimensional codes, but can also be pre-stored in NFC chips, RFID chips, SIM cards, SD cards, and other chips that can store information. The carrier of the chip is not limited to cards and smart phones, and can be any other physical structure.

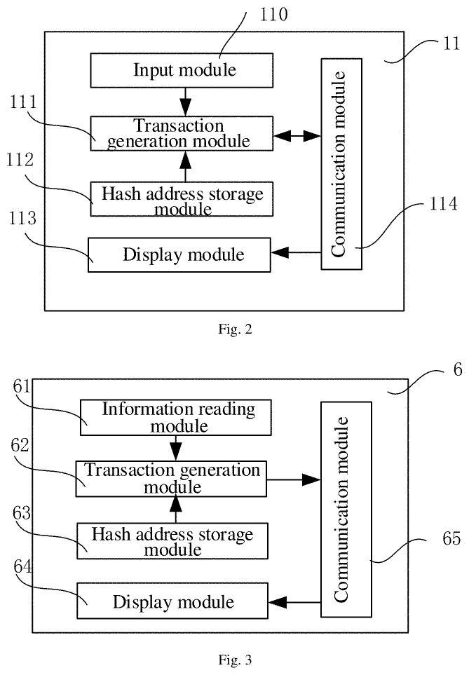

FIG. 2 is a structural block diagram of a user terminal. As shown in FIG. 2, the user terminal 11 includes an input module 110, a transaction generation module 111, a hash address storage module 112, a display module 113, and a communication module 114.

The hash address storage module 112 stores at least the hash address of the user A in the block chain (account address in the block chain), and the hash address of the management center 5 in the block chain (account address in the block chain). The input module 110 is used to input the amount of digital currency moved to the hash address of the management center 5, and the hash address storage module 112 selects the hash address of the user A in the block chain and the hash address of the management center 5 in the block chain.

The hash address storage module 112 is optional. The hash address of the user A in the block chain and the hash address of the management center 5 in the block chain can be input by the input module 110. The input methods include keyboard input, camera reading and direct input after identifying.

The transaction generation module 111 generates a transaction. The transaction information includes the amount of digital currency input by the user and the information of that the digital currency moved from the hash address of the user A in the block chain to the hash address of the management center 5 in the block chain.

The transaction generated by the transaction generation module 111 is sent to the digital currency block chain system 3 through the communication module 114. After the node 1 . . . n confirms the transaction, the transaction block is recorded at the end of the block chain, and the digital currency is moved to the hash address of the management center 5 in the block chain. After the data of the user terminal 11 and the block chain is synchronized, the display module 113 displays whether the digital currency has been moved to the hash address of the management center. If it is not successful, the user can choose to operate again until it is successful. Therefore, whether the digital currency is successfully moved to the hash address of the management center 5 in the block chain can be confirmed by the user through the display of the current display module, that is, whether the recharge is successful can be confirmed.

FIG. 3 is a structural block diagram of a settlement terminal. As shown in FIG. 3, the settlement terminal 6 includes an information reading module 61, a transaction generation module 62, a hash address storage module 63, a display module 64, and a communication module 65.

The information reading module 61 has a function of reading the hash address of the user from the payment device 1 and a function of inputting or reading the amount of digital currency paid by the user.

The hash address storage module 63 stores at least the hash address of the management center 5 in the block chain, and the hash address of the user B in the block chain can be stored in the hash address storage module 63 or input through the information reading module 61.

The transaction generation module 62 generates a transaction, and the transaction information includes the hash address of the user A in the block chain read from the payment device 1, the hash address of the user B receiving payment in the block chain and the amount of digital currency moved from the read hash address of the user A in the block chain to the hash address of the user B receiving payment in the block chain.

The user receiving payment is not limited to user B, for example, user A1 may also pay user A2. In the following, user A as the user paying and user B as the user receiving the payment are taken examples for description.

In the prior art, the transaction of digital currency movement is directly sent to the block chain system, and the transaction is completed after being confirmed by the node. In the present invention, the transaction generated by the settlement terminal 6 is sent to the management center 5 through the communication module 65 for unified processing. Since the transaction is not directly sent to digital currency block chain system 3, the node will no need to confirm each transaction, which reduces the cost and time spent on confirmation.

The display module 64 displays information sent by the management center 5, such as successful transaction or error message of insufficient balance.

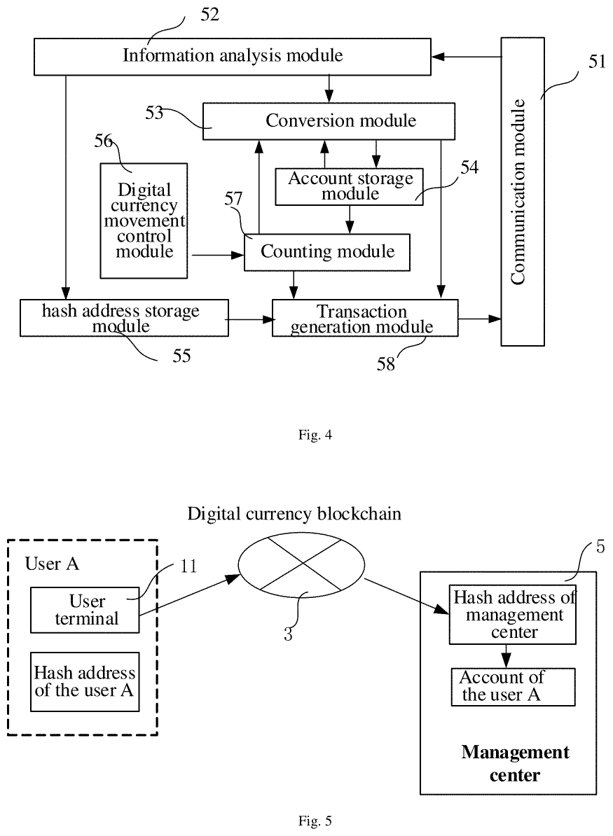

FIG. 4 is a structural block diagram of the management center. As shown in FIG. 4, the management center 5 includes a communication module 51, an information analysis module 52, a conversion module 53, an account storage module 54, a hash address storage module 55, a digital currency movement control module 56, a counting module 57, and a transaction generation module 58.

The communication module 51 is used to communicate with the network server 4 and the digital currency block chain 3, receive the transactions sent by the settlement terminal 6 and move the digital currency in the digital currency block chain 3.

The account storage module 54 stores accounts of users including user A and user B. The account is registered by the user's real name in the management center.

The conversion module 53 performs conversion between the digital currency and the intermediate currency. The intermediate currency can be the digital currency itself, or any real currency in circulation, such as US dollar and RMB. The conversion rate can be fixed or the actual exchange rate at the time of conversion.

The hash address storage module 55 stores the hash address of each user including user A and user B in the block chain and the hash address of the management center 5 in the block chain.

The counting module 57 counts the amount of intermediate currency entering the account of the user B in a period of time.

The digital currency movement control module 56 controls the counting module 57 to count the total amount of intermediate currency in the accounts of users (such as user B) who receive intermediate currency. The counting module 57 can set a time period for counting the total amount of intermediate currency in the user Account, or set a threshold value for the total amount of digital currency, and counting are performed when the threshold is exceeded.

The counting result of the counting module 57 is converted into the amount of digital currency by the conversion module 53, and then input to the transaction generation module 58.

The transaction generation module 58 reads the hash address of the user (such as user B) in the block chain and the hash address of the management center 5 in the block chain from the hash address storage module 55 to generate a transaction. The transaction information includes hash addresses of users (such as user B) and management center 5 in the block chain, and the amount of digital currency moved from hash addresses of management center 5 to hash addresses of users (such as user B) in the block chain.

The generated transaction is sent to the digital currency block chain system 3 through the communication module 51. After the transaction is confirmed by the nodes 1 . . . n, the digital currency is moved to the hash address of the user (such as user B) in the block chain.

The workflow of the digital currency settlement system is described below.

FIG. 5 is an explanatory diagram of recharging a payment device from a user terminal.

The user A operates the user terminal 11 to move a certain amount of digital currency to the hash address of the management center 5 in the block chain.

After synchronizing with the data of the block chain, the management center 5 converts the amount of received digital currency into the amount of intermediate currency, and records the corresponding amount of the intermediate currency in the account of the user A.

The management center 5 manages the amount of digital currency paid by the user A with the payment device 1 by managing the intermediate currency in the account of the user A.

The digital currency corresponding to the amount of the intermediate currency in the account of the user A is the amount of digital currency that the user A can pay through the payment device 1.

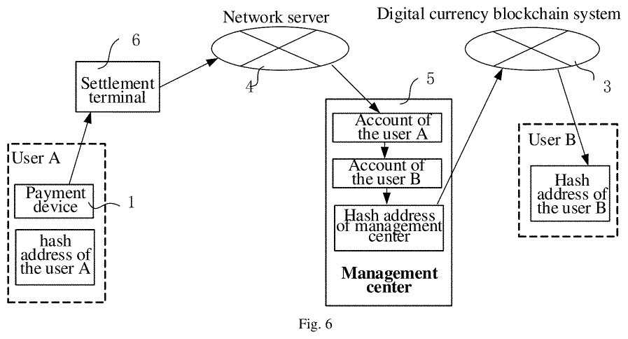

FIG. 6 is an explanatory diagram of digital currency movement (transfer) when paying with a payment device.

When the user A pays the digital currency to the user B through the payment device 1 at the settlement terminal 6, the settlement terminal 6 at least reads the hash address of the user A in the block chain in the payment device 1 to generate a transaction, that is, a transaction for moving the digital currency from the block chain address of the user A to the block chain address of the user B. The block chain address of the user B is pre-stored in the settlement terminal 6 or input by the user. The amount of digital currency is entered by the price bar code attached to the purchased goods, or manually input by the user.

The transaction is sent to the management center 5 through the network server 4. The management center 5 moves the intermediate currency corresponding to the amount of digital currency from the account of the user A to the account of the user B. After a certain period of time or the amount of intermediate currency reaches a certain value, the management center 5 counts the total amount of intermediate currency in the account of the user B. The digital currency corresponding to the total amount of the intermediate currency is moved from the hash address of the management center 5 in the block chain to the hash address of the user B in the block chain.

Since the transaction is sent to the management center 5 when the user A pays the user B with digital currency through the settlement terminal 6, the management center 5 moves the corresponding amount of intermediate currency from the account of the user A to the account of the user B according to the amount of digital currency, and moves the corresponding digital currency from the account address of the management center 5 to the account address of the user B after a certain time or after the intermediate currency in the account of the user B reaches a certain amount. Therefore, compared with the prior art that transactions are sent to the block chain and each node confirms the transactions every time payment is made, not only the cost of verification is saved, but also the time of waiting for verification is saved, and the practicability of paying with digital currency is improved. If the payment object is wrong and user A needs to stop paying, because there is a time lag for digital currency to enter the account of the user B, the user can apply to the management center to stop the payment to user B, which improves security.

The flow of digital currency settlement system is described below.

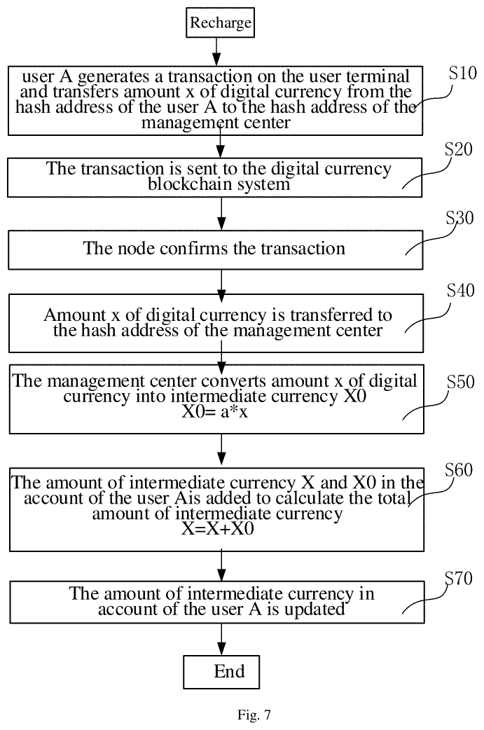

FIG. 7 is a flow chart of recharging a payment device from a user terminal.

At step S10, user A operates the user terminal to generate a transaction, an amount x of digital currency is moved from the hash address of the user A in the block chain to the hash address of the management center 5 in the block chain.

At step S11, the generated transaction is sent to the digital currency block chain system 3.

At step S12, the nodes in the digital currency block chain system confirm the transaction.

At step S13, after the transaction is confirmed, the transaction block is recorded at the end of the digital currency block chain, and amount x of digital currency is transferred to the hash address of the management center 5 in the block chain.

At step S14, after data synchronization between the management center 5 and the digital currency block chain system, the amount x of received data currency is converted into the amount X0 of intermediate currency according to the following formula.

X0=a*x, where a is the conversion rate

At step S15, the management center 5 deposits the amount X0 of intermediate currency into the account of the user A. If account of the user A already has the amount x of intermediate currency, the management center 5 calculates the total amount according to the following formula.

x=x+x0

At step S16, the management center 5 updates the amount of intermediate currency in the account of the user A.

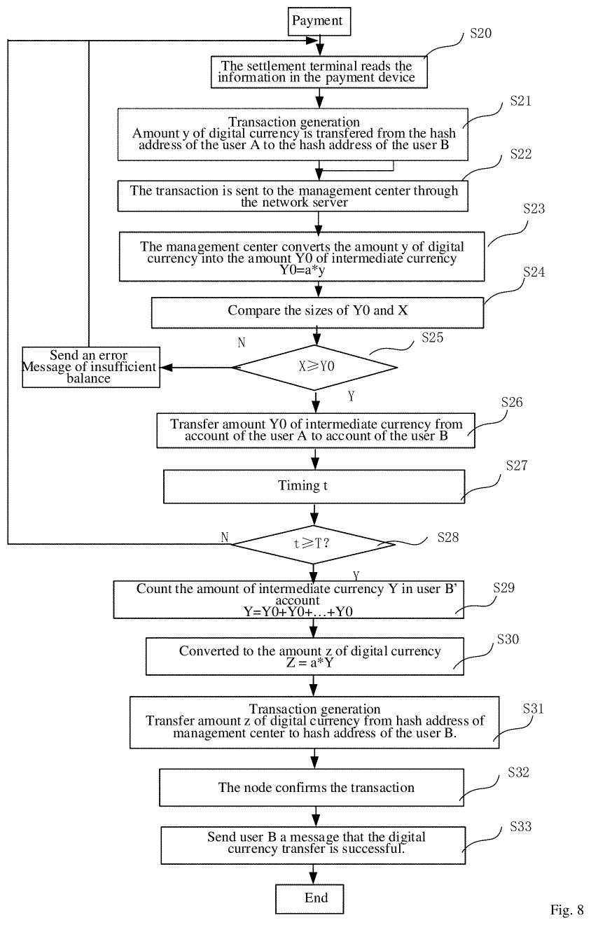

FIG. 8 is a flow chart of digital currency movement (transfer) when paying with a payment device.

At step S20, the settlement terminal 6 reads the hash address of the user A in the block chain from the payment device 1.

At step S21, the settlement terminal 6 generates a transaction, and the transaction information includes the read hash address of the user A in the block chain, the hash address of the user B in the block chain, and the amount y of digital currency moved from the hash address of the user A to the hash address of the user B in the block chain.

At step S22, the settlement terminal 6 sends the transaction to the management center 5 through the network server 4.

At step S23, after the management center 5 receives the transaction, since the hash address of the user A in the block chain is associated with the account of the user A, the hash address of the user B in the block chain is associated with the account of the user B, the accounts of the user A and user B are determined according to the hash address of the user A in the block chain and the hash address of the user B in the block chain in the transaction information.

The management center 5 converts the amount y of digital currency in the transaction into the amount Y0 of intermediate currency according to the following formula.

Y0=a*y, where a is the conversion rate, and the conversion rate a may or may not be consistent with the conversion rate a at step S14.

At step S24, the management center 5 reads the intermediate currency X in the account of the user A, and compares the sizes of Y0 and X.

At step S25, the management center 5 judges the result of the comparison. If X≥Y0, proceed to step S26, otherwise, proceed to step S34, send an error message of insufficient balance to the settlement terminal 6, and then return to step S20.

At step S26, the management center 5 transfers the amount Y0 of intermediate currency from the account of the user A to the account of the user B.

At step S27, the management center 5 performs timing.

The timing can be performed at a set time interval, or it can be started after the first transfer of intermediate currency into the account of the user B. The first transfer of intermediate currency is not limited to the account of the user A, but can be any other user's account.

At step S28, the management center 5 judges whether t≥T, if t<T, return to step S20, and wait for the next payment. If t≥T, proceed to step S29.

At step S29, the management center 5 clears the timing, and counts the amount Y0 of intermediate currency transferred into the account of the user B according to the following formula.

Y=Y0+ . . . +Y0

At step S30, the management center 5 converts the amount z of digital currency according to the following formula. After the conversion is completed, the management center 5 marks the processed currency in the account of the user B as processed to prevent the data from being used again.

Z=a*Y, where the conversion rate a may or may not be consistent with the conversion rate a at steps S14 and S23.

At step S31, the management center 5 generates a transaction, and the transaction information includes the hash address of the management center 5 in the block chain and the hash address of the user B in the block chain, and the amount z of digital currency moved from the hash address of the management center 5 in the block chain to the hash address of the user B in the block chain.

At step S32, the node 1 . . . n of digital currency block chain system 3 confirms the transaction.

At step S33, the management center 5 synchronizes the data with the digital currency block chain system 3, and after confirming that the amount z of digital currency has been moved to the hash address of the user B in the block chain, it sends an information through the network server 4 to user B that the digital currency has been transferred to the account of the user B.

Therefore, user B can know the digital currency paid by users including user A through the information sent by the management center 5 through the display module.

The specific embodiments of the present invention have been described above. In the prior art, the transaction generated by the settlement terminal is directly sent to the block chain system, and the transaction is completed after being confirmed by the node. In the present invention, the transaction generated by the settlement terminal 6 is sent to the management center 5 through the communication module 65 for processing. That is, when user A pays with the payment device 1, the management center 5 moves the corresponding amount of intermediate currency from account of the user A to the payee's account. Therefore, when paying with payment device 1, only the intermediate currency is moved between accounts in management center 5, and the digital currency in the digital currency block chain system 3 is not moved. After a certain period of time, the management center 5 counts the total amount of intermediate currency in the account of the user B, and moves the corresponding amount of digital currency from the digital currency account of the management center 5 to the digital currency account of the user B. Since the transaction is not directly sent to the digital currency block chain system 3, the node will not confirm every transaction, which reduces the transaction cost and time spent on transaction confirmation. Users who want to pay can also make payment in digital currency without network.

In addition, in the above embodiment, step S25 may also be modified to be that the management center 5 judges the result of the comparison. If X+m≥Y0, proceed to step S26, otherwise proceed to step S34. m is the allowed amount of overdraft. In this way, even if the recharged digital currency is insufficient for payment, overdraft payment can be made, and the overdraft amount can be offset when recharging later.

In order to prevent the payment device 1 from being used abnormally without the user's knowledge, the payment device may adopted in the following varied examples to improve the security.

In the above embodiment, the method of making payment through the digital currency settlement system has been described with the user A as an example, and the user A may be one or more than one. The user B receiving payment may be one or more than one, that is, the user A may pay digital currency to a plurality of different users B.

The flow of digital currency settlement method is described below.

Reading step: the information reading module 61 of the settlement terminal 6 reads at least the account address of the user A in the digital currency block chain 3 from the payment device 1.

Information identifying and transaction generation step: the information reading module 61 of the settlement terminal 6 identifies the read information, and the transaction generation module 62 generates a transaction according to the identified information, and the transaction is sent to the management center 5 from the communication module 65 through the network server 2. The transaction information includes the account address of the user A in the digital currency block chain read by the payment device 1, the account address of the user B receiving the payment in the digital currency block chain, and the amount y of digital currency moved from the account address of the user A in the digital currency block chain to the account address of the user B in the digital currency block chain. The account address of the user B in digital currency block chain can be read by reading tags of goods or manual input by the user when shopping.

Intermediate currency conversion step: the account storage module 54 of the management center 5 stores at least the accounts of the user A and user B, and the hash address storage module 55 stores at least the account addresses of the management center 5 in the block chain. The accounts of the user A and user B are used for the transfer of intermediate currency, and a certain amount of intermediate currency is pre-stored in the account of the user A. The information analysis module 52 of the management center 5 analyzes the information in the transaction, and obtains the account address of the user A in digital currency block chain, the account address of the user B in digital currency block chain, and the amount of digital currency moved. The conversion module 53 converts the amount y of digital currency into a corresponding amount Y0 of intermediate currency according to the amount information of the digital currency.

Intermediate currency moving step: the account storage module 54 of the management center 5 moves the corresponding amount Y0 of intermediate currency from the account of the user A to the account of the user B.

Counting step: the digital currency movement control module 56 of the management center 5 controls the counting module 57 to count the total amount y of intermediate currency in the account of the user B after a certain time or after the amount of intermediate currency transferred to the account of the user B reaches a certain amount.

Digital currency conversion step: the conversion module 53 of the management center 5 converts the total amount of intermediate currency into a corresponding amount Z of digital currency.

Transaction generating and sending step: the transaction generating module 58 of the management center 5 generates a transaction of moving digital currency to the user B, and sends the transaction to the digital currency block chain 3 through the communication module 51, and after confirmation by the nodes (1 . . . n), records the transaction as a block at the end of the block chain. The transaction information includes the account address of management center 5 in the block chain, the account address of the user B in the block chain, and the amount Z of digital currency moved from the account address of management center 5 in the block chain to the account address of the user B in the block chain.

Account processing step: after the transaction is generated, the intermediate currency corresponding to the amount of moved digital currency in the account of the user B is marked. After the digital currency is successfully moved, the management center 5 subtracts the corresponding amount of intermediate currency from the account of the user B.

The second embodiment is described below.

In the first embodiment, since the payment device 1 uses the two-dimensional code encoded with an account address, and any identifying device can generate a transaction once reading the account address, and once the payment device 1 is out of management of the user, it is easy to have abnormal use problems, such as embezzlement.

The second embodiment is to improve the security of payment with the payment device 1. The following description mainly focuses on the parts that improve safety, and the parts that are the same as those in the above-mentioned embodiment will not be described again.

The network server 4 stores relevant information associated with the user information S. Before generating and sending a transaction, the settlement terminal 6 sends the user information S to the network server 4, and the network server 4 generates matching information according to the user information S sent by the settlement terminal 6.

The payment device 1 adopts the card or smart phone structure as shown in FIGS. 10, 12 and 15, and at least two fields of information are encoded into the printed or displayed QR code. The first field information includes the account address D1 of the user A in the digital currency block chain 3, and the second field information includes the user information S. The user information S may be subordinate to the account address D1.

The information reading module 61 of the settlement terminal 6 decomposes the read information to obtain the address of the account of the user A and the user information S. The user information S in the second field is sent to the network server 4 through the communication module 65. The transaction generation module 62 of the settlement terminal 6 verifies the user identity according to the matching information sent by the network server 4. For users who have passed identity verification, a transaction is generated according to the account address D1 in the first field.

The flow of the digital currency settlement method according to the second embodiment is described below.

In the flows of the digital currency settlement method of the first and second embodiments, all the steps are the same except the information identifying transaction generation steps. The information identifying and transaction generation step in the second embodiment is described below.

Information identifying and transaction generation step: before generating a transaction, the second field information identified is sent to the network server 4, and the network server 4 generates matching information, verifies the user identity according to the matching information, and generates a transaction for the user who passes the identity verification.

If the matching information generated by the network server 4 is a password, the settlement terminal 6 judges whether the password input by the user is correct according to the password in the matching information to verify the user identity.

If the matching information generated by the network server 4 is a mobile phone number, the settlement terminal 6 sends a verification code to the mobile phone number according to the mobile phone number in the matching information, and judges whether the verification code input by the user is correct to verify the user identity.

If the matching information generated by the network server 4 is time or/and position information, the settlement terminal 6 verifies whether the transaction is conducted at the specified time or/and position according to the time or/and position of the matching information and the current time or/and the current position of the payment device 1 (settlement terminal 6).

Therefore, compared with the first embodiment, the second embodiment improves the security of the payment device 1, and even if the payment device 1 is out of the user's management, others cannot use the payment device 1 to make payments, thus preventing abnormal use of the payment device.

The first field may include website information, and the account address D1 of the user A is included in the website information.

The second field may include website information, and the user information S is included in the website information. The second field information may be encoded or encrypted information.

The second field includes control information that requires password input.

The payment device is described below.

The payment device 1 includes an information carrier 11 and payment information 12 stored on the information carrier, wherein the payment information includes at least two fields of information, the first field information includes the account address D1 of the user A in the digital currency block chain 3, and the second field information includes user information S, which is subordinate to the account address D1 and is used for verifying the user.

As shown in FIGS. 10, 12, and 15, the payment information 12 is printed or displayed on the information carrier in the form of graphic codes, which may be two-dimensional codes (such as QR codes), bar codes or other codes, and are read by an optical identifying device.

The information carrier 11 may be a memory chip, and the payment information 12 is stored on the memory chip. The memory chip includes at least any of NFC chip, RFID chip, SIM card and SD card, and can be read by near field or being directly inserted into a card reader.

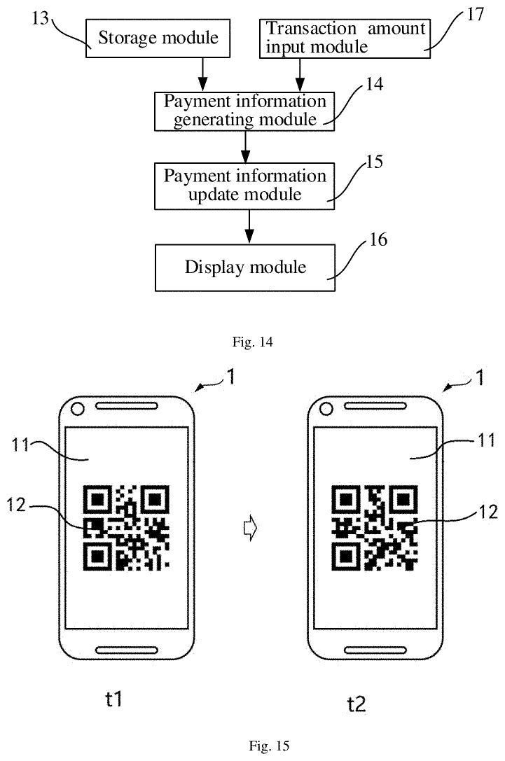

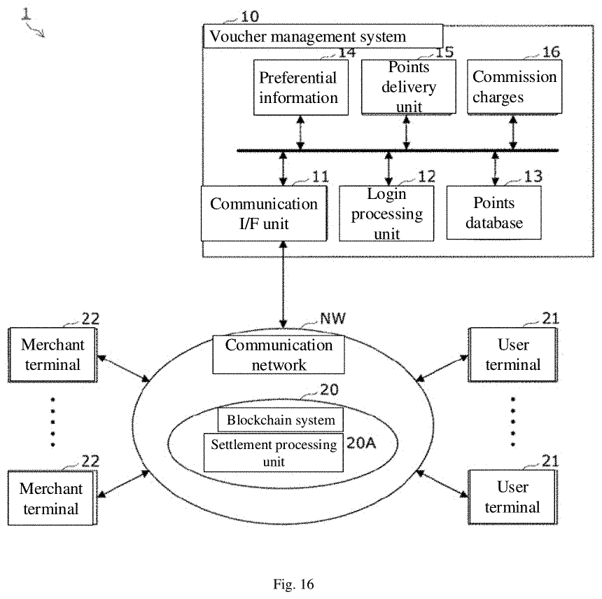

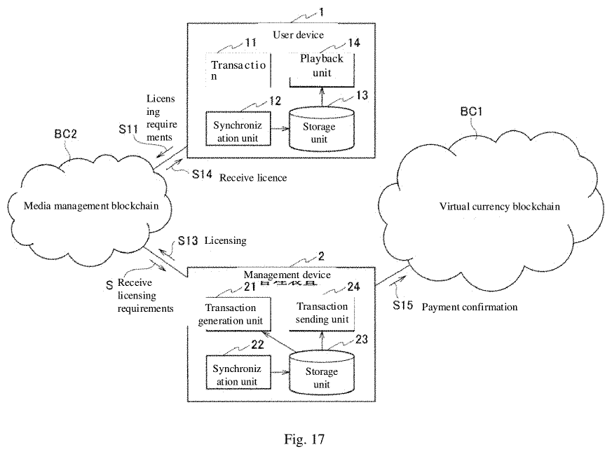

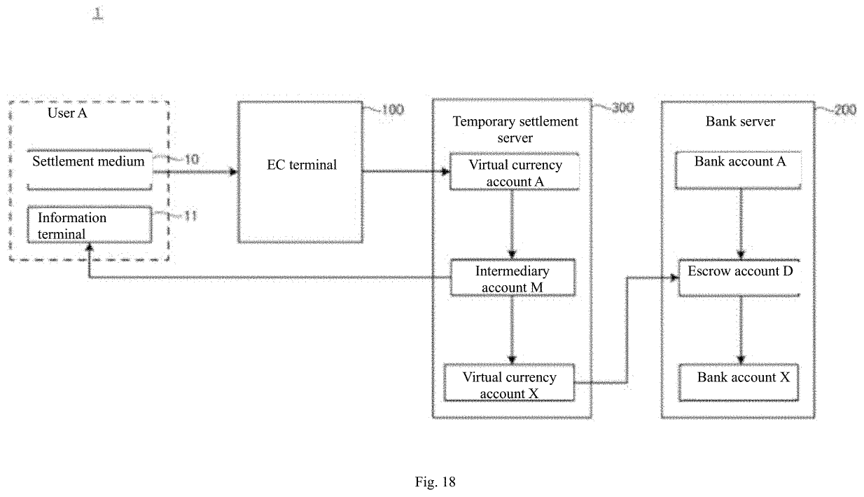

FIG. 14 is a structural diagram of a payment device according to a varied example. As shown in FIG. 14, the payment device 1 includes a storage module 13, a payment information generating module 14, and a display module 16. The storage module 13 stores a key and user information S. The payment information generating module 14 generates an account address D1 by using the key, and generates the first field information including the account address D1, and the second field information including the user information S. The display module 16 displays and updates the payment information in the form of graphic codes or electronic signals.

The technology for improving the security of the payment device is described below through other embodiments.

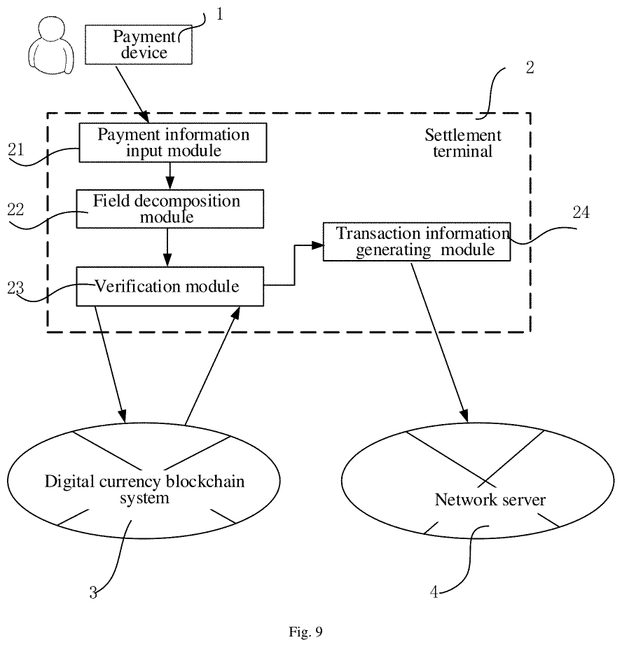

FIG. 9 is a structural block diagram of a digital currency settlement system according to another embodiment;

As shown in FIG. 9, the digital currency settlement system consists of a payment device 1, a settlement terminal 2, a digital currency block chain system 3, and a network server 4. As a digital currency, Bitcoin will be taken as an example in this embodiment for description.

The digital currency block chain system 3 records every transaction in the way of a block chain, and is a decentralized transaction recording system. Blocks containing transaction information after transaction broadcasting are recorded at the end of the block chain. Any node can view each transaction and verify it.

The network server 4 stores relevant information associated with the user information S, and generates matching information according to the user information S.

The payment device 1 provides payment information, which includes a first account address D1 for transferring out bitcoin when the settlement terminal 2 generates a transaction. The payment information includes at least two fields of information, the first field information includes the first account address D1 (hash address), and the second field information includes user information S. The user information S is used to verify the authorization of the transaction. In this embodiment, the payment device 1 adopts a payment card identified by an optical system. Hereinafter, for convenience of description, unless otherwise specified, the payment device will be referred to as payment card 1 for short. A two-dimensional code as payment information is printed or displayed on the payment card 1.

The settlement terminal 2 includes a payment information input module 21, a field decomposition module 22, a verification module 23, and a transaction information generating module 24. Corresponding to the payment card 1, the payment information input module 21 adopts an optical identifying module that can optically identified. Hereinafter, for convenience of description, unless otherwise specified, the payment information input module will be referred to as the optical identifying module 21 for short.

The optical identifying module 21 optically reads the two-dimensional code on the payment card 1 and obtains payment information by decoding.

The field information decomposition module 22 decomposes the payment information to obtain the first field information and the second field information.

The verification module 23 sends the user information S in the second field to the network server 4, obtains the matching information sent by the network server 4, and verifies the authorization to use the first account address D1 to generate a transaction accounted in the digital currency block chain 3 based on the matching information.

The transaction information generating module 24 generates the transaction, which includes the amount of bitcoin to be transferred (transfer amount), the first account address D1 for transferring out, and the second account address D2 for transferring in.

The digital currency block chain 3 records the transaction in the block chain as a block.

Therefore, when paying, the user only needs to show the payment card 1, and the settlement terminal 2 can read the two-dimensional code on the payment card 1 to generate a transaction. The user can pay without going online, and does not need to wait for the verification result of the transaction by the node, thus improving the user experience of using digital currency.

The payment card is described below.

FIG. 10 is an outline view of a payment card. As shown in FIG. 10, the payment card 1 uses a card as an information carrier 11, and a QR code (two-dimensional code) 12 is printed on the surface of the card as payment information.

FIG. 11 is an enlarged view of the QR code 12 on the payment card 1. The QR code 12 includes two fields of information, which can be identified by an optical identifying device. For example, the QR code 12 is encoded with the following payment information:

http://www.bitcoin.com/abc/XE23KQBMCX8SE31S5K8UA1TJC0340R10P5F? http://www.xcoin.com/bcd/WD45VFG34P

This information consists of two fields. The first field is:

http://www.bitcoin.com/abc/XE23KQBMCX8SE31S5K8UA1TJC0340R I0P5F;

The second field is:

http://www.xcoin.com/bcd/WD45VFG34P;

The special character “?” is used between fields for distinguish, therefore, the first field information and the second field information can be distinguished when the field decomposition module 22 detects “?”. “As a method for distinguishing fields, in addition to using special characters that will not appear in the fields, the first field information and the second field information can also be distinguished by setting the length of the string. The second field information is also encoded or encrypted information.

The first field is the website address, which includes the first account address D1 in the digital currency block chain 3, that is, the address of the user in the digital currency block chain 3.

The second field is another website, which includes user information S.

In the above embodiment, the payment information is printed in the form of QR code on the card used as the information carrier, but the payment information can also be directly stored in the memory chip for use, that is, the memory chip is used as the information carrier to store payment information.

The memory chip can be any type of chip, such as common NFC chip, RFID chip, SIM card and SD card, and can be read by near field or being directly inserted into a card reader, that is, the payment information input module 21 corresponding to the memory chip is used instead of the optical identifying module to input payment information.

In this embodiment, the payment card 1 serving as the information carrier 11 is a card, but the information carrier 11 may also be a display screen.

FIG. 12 is an explanatory diagram for displaying payment information 12 on a display screen of a smart phone.

That is, the smart phone is used as the payment device 1, and the payment information 12 is stored in the smart phone. When paying, the smart phone is operated to display the QR code 12 on the display screen, so that payment can be made in the same way as the payment card 1. For users with smart phones, there is no need to carry another payment card, thus improving the convenience of users.

### Embodiment 1

The matching information of the network server 4 includes a password, and the verification module 23 judges whether the password input by the user is correct according to the password in the matching information to perform authorization verification.

### Embodiment 2

The matching information of the network server 4 includes a mobile phone number, and the verification module 23 sends a verification code to the mobile phone number according to the mobile phone number in the matching information, and judges whether the verification code input by the user is correct to perform authorization verification.

### Embodiment 3

The matching information of the network server 4 includes time or/and position information, and the verification module 23 performs authorization verification according to the time or/and position of the matching information and the current time or/and transaction position, that is, by setting the period of use or/and transaction position of Bitcoin, it verifies whether the payment is made within a set period or/and a specified area. The position of the transaction can be determined by the position of the payment card 1. Since there is a close distance between the payment card 1 and the settlement terminal 2 during payment, the position of the payment card 1 can be determined by determining the position of the settlement terminal 2, without additional means for determining the position of the payment card 1, thus simplifying the structure.

In order to increase security, the second field information can be encoded or encrypted cipher text information.

In the second field, control information requiring password input can also be added.

The settlement method of digital currency is described below.

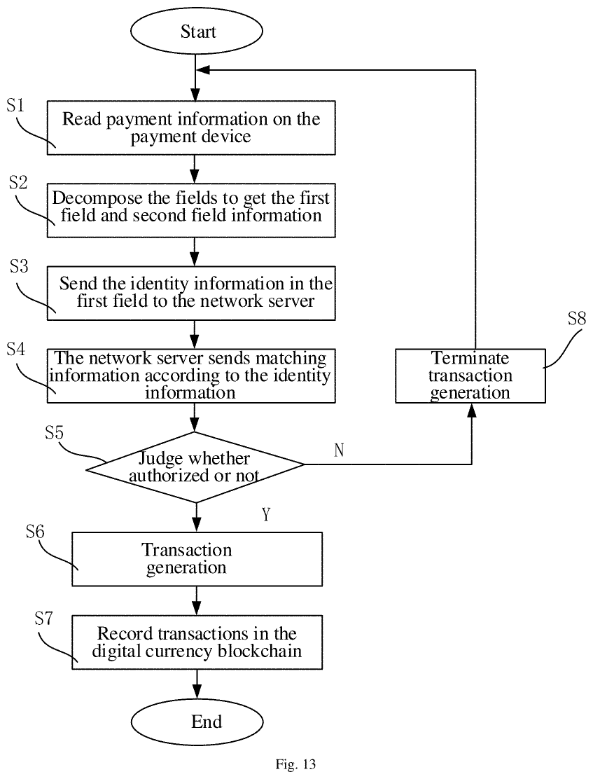

FIG. 13 is a flow chart of the settlement method.

At step S1 (reading step), the settlement terminal 2 reads the two-dimensional code on the payment card 1 through the optical identifying module 21, and obtains payment information through decoding.

At step S2 (field decomposition step), the payment information is decomposed into the first field information and the second field information when the special symbol “?” detect is detected.

Step S3, the user information S in the second field is sent to the network server 4.

Step S4, the network server 4 searches the matching information associated with the user information S according to the user information S, and sends the matching information to the settlement terminal 2.

Step S5, after obtaining the matching information sent by the network server 4, the settlement terminal 2 verifies the authorization to use the first account address to generate a transaction accounted in the digital currency block chain 3 based on the matching information. That is, when the matching information is a password, the password is compared with the input password, and if they are consistent, it is considered authorized. When the matching information is a mobile phone number, a verification code is sent to the mobile phone number, and the verification code is compared with the input verification code, and if they are consistent, it is considered authorized.

If the matching information includes time and position, it is also judged whether the conditions are met according to the current time and the position when the payment card 1 is used.

When all the conditions in the matching information are met or consistent, it is considered authorized, and the process proceeds to step S6.

At step S6, the settlement terminal 2 generates a transaction, which includes a transfer amount, a first account address D1 for transferring out and a second account address D2 for transferring in.

At step S7, the transaction is sent to the network and recorded in the digital currency block chain 3 after being verified by the nodes.

Steps 3-5 constitute the verification steps in the claims.

Other embodiments of the payment device 1 are described below.

FIG. 14 is an explanatory diagram of a payment device.

The payment device 1 includes a storage module 13, a payment information generating module 14, a LCD module 16, and a transaction amount input module 17. The payment device 1 may be a standalone device, or it may be set up and used in a smart phone, and the payment information is displayed on the LCD screen of the smart phone.

The storage module 13 stores a key and user information S. The payment information generating module 14 generates the first account address D1 by using the key, and generates payment information. The payment information includes the first field information including the first account address D1, the second field information including the user information S, and the transaction amount input through the transaction amount input module 17. The LCD module 16 displays and updates the payment information in the form of QR codes.

That is, compared with the embodiment shown in FIG. 9, the device for inputting the transaction amount is changed from the settlement terminal 2 to the payment device 1.

Therefore, as shown in FIG. 15, the QR code pattern displayed when paying at time t1 and the QR code pattern displayed when paying at time t 2 payment are different, so that each time the LCD module 16 displays a different QR code image, and the security is further improved compared with the payment card. In the payment device 1, the transaction amount input module 17 is optional. For example, any other changing information such as transaction time information can also be added, as long as the QR code pattern generated each time varies. The LCD module 16 can also be replaced by other modules such as Bluetooth, NFC or WIFI modules to output payment information.

The specific embodiments and examples of the present invention have been described above, and any other varied examples can be made to the present invention. For example, in the embodiment, Bitcoin is used as the digital currency, but the currency is not limited to Bitcoin or inputting any other form of digital currency, and can also be vouchers or points in digital form. Therefore, all the varied examples within the technical idea of the present invention fall within the scope of the present invention.

1. A digital currency settlement system, comprising a payment device (1), a digital currency block chain system (3), a network server (4), a management center (5), and a settlement terminal (6), wherein the management center (5) is respectively connected with the network server (2) and the digital currency block chain system (3), the settlement terminal (6) is connected to the management center (5) through the network server (2), and there are also nodes 1 . . . n connected that can confirm transactions in the digital currency block chain system (3) in addition to user B and the management center (5),
the payment device (1) is used for paying digital currency to other users, and the payment device (1) at least stores account addresses of the users in the digital currency block chain (3),
when the user A pays or transfers the digital currency to the user B by using the payment device (1),
the settlement terminal (6) reads at least an account address of user A in the digital currency block chain (3) from the payment device (1), and generates a transaction after identifying the information, the transaction is sent to the management center (5) through the network server (2), and the transaction information comprises the account address of the user A in the digital currency block chain read by the payment device (1), an account address of the user B who receives a payment in the digital currency block chain, and an amount y of digital currency moved from the account address of the user A in the digital currency block chain to the account address of the user B in the digital currency block chain,
the management center (5) stores at least the account addresses of the user A and the user B, and an account address of the management center (5) in the block chain, wherein accounts of the user A and the user B are used for transferring the intermediate currency, and a certain amount of intermediate currency is pre-stored in the account of the user A, the management center (5) converts the amount y of digital currency in the transaction information into a corresponding amount Y0 of intermediate currency according to the received transaction, and moves the corresponding amount Y0 of intermediate currency from the account of the user A to the account of the user B, after a certain time or after the intermediate currency transferred to the account of the user B reaches a certain amount, the management center (5) counts a total amount Y of intermediate currency in the account of the user B, converts the total amount Y of intermediate currency into a corresponding amount Z of digital currency, and sends the transaction to the digital currency block chain (3), and records the transaction as a block at an end of the block chain and after confirmation by the nodes (1 . . . n), the transaction information comprises the account address of the management center (5) in the block chain, the account address of the user B in the block chain, and the amount Z of digital currency moved from the account address of the management center (5) to the account address of the user B in the block chain; after the digital currency is successfully moved, the management center (5) subtracts a corresponding amount of intermediate currency from the account of the user B.

2. The digital currency settlement system according to claim 1, further comprising a user terminal (11),
wherein the user terminal (11) generates the transaction and moves the digital currency to the account address of the management center (5) in the block chain before the user A uses the payment device (1) to pay the digital currency to other users.
The transaction information comprises the account address of user A in the block chain, the account address of management center (5) in the block chain, and the amount x of digital currency moved from the account address of user A to the account address of management center (5) in the block chain;
According to the received transaction, the management center (5) converts the amount x of digital currency in the transaction information into corresponding amount X0 of intermediate currency, and records the corresponding amount X0 of intermediate currency in the account of the user A to recharge the payment device (1) of the user A.

3. The digital currency settlement system according to claim 2, wherein the user A comprises more than one user who move the digital currency to the account address of the user B in the digital currency block chain, and each of the user A has a different account address in the digital currency block chain.

4. The digital currency settlement system according to claim 3, wherein
the management center (5) judges whether an amount X of the intermediate currency in the account of the user A is greater than or equal to the corresponding amount Y0 when the corresponding amount Y0 of intermediate currency is moved from the account of the user A to the account of the user B, when the amount X of the intermediate currency in the account of the user A is greater than or equal to the corresponding amount Y0, the corresponding amount Y0 of intermediate currency is moved from the account of the user A to the account of the user B.

5. The digital currency settlement system according to claim 3, wherein
the management center (5) judges whether the amount X+m of intermediate currency in account of user A is greater than or equal to the corresponding amount Y0 when the corresponding amount Y0 is moved from account of user A to account of user B, when the amount X+m of intermediate currency in the account of user A is greater than or equal to the corresponding amount Y0, Y0 amount of intermediate currency is moved from the account of user A to the account of user B, where m is the overdraft amount of intermediate currency.

6. The digital currency settlement system according to claim 5, wherein
the user terminal (11) comprises an input module (110), a transaction generation module (111), a block chain account address storage module (112), and a communication module (114),
the block chain account address storage module (112) at least stores the account address of the user in the block chain and the account address of the management center (5) in the block chain,
the input module (110) is used for inputting an amount of digital currency moved to the account address of the management center (5), and the block chain account address storage module (112) selects the account address of the user and the account address of the management center (5) in the block chain.
the transaction generating module (111) generates a transaction, and the transaction information comprises the amount of digital currency input by the user and the information that the amount of digital currency is moved from the account address of the user in the block chain to the account address of the management center (5) in the block chain.

7. The digital currency settlement system according to claim 6, wherein the settlement terminal (6) comprises an information reading module (61), a transaction generating module (62), an account address storage module (63), a display module (64), and a communication module (65),
the information reading module (61) has the functions of reading the account address of the user in the block chain from the payment device (1) and inputting or reading the amount information of digital currency paid by the user; the account address storage module (63 stores) at least the account address of user B receiving payment in the block chain; the transaction generation module (62) generates a transaction, and the transaction information comprises the read account address of user A in the block chain, the account address of user B receiving payment in the block chain, and the amount of digital currency moved from the read account address of user A in the block chain to the account address of user B receiving payment in the block chain.

8. The digital currency settlement system according to claim 7, wherein the management center (5) comprises a communication module (51), an information analysis module (52), a conversion module (53), an account storage module (54), an account address storage module (55), a digital currency movement control module (56), and a counting module (57),
the communication module (51) is used for communicating with the network server (4) and the digital currency block chain (3), receiving the transactions sent by the settlement terminal (6), and sending the transactions to the digital currency block chain (3),
the account storage module (54) stores accounts of users comprising user A and user B,
the conversion module (53) performs conversion between digital currency and intermediate currency,
the account address storage module (55) stores the account addresses of each user comprising user B in the block chain and the account addresses of the management center (5) in the block chain, the account of each user is associated with the account address in the block chain,
the statistics module (57) counts the amount of intermediate currency in the account of the users,
the digital currency movement control module (56) controls the statistics module (57) to count the total amount y of the intermediate currency in the account of the user B who receives intermediate currency, and the counting result is converted into the amount Z of digital currency by the conversion module (53) and then input to the transaction generation module (58).
the transaction generation module (58) reads the account address of the user B in the block chain and the account address of management center (5) in the block chain from the account address storage module (55) to generate transactions, the transaction information comprises the account address of the user B in the block chain and the account address of management center (5) in the block chain, the amount Z of digital currency is moved from the account address of the management center (5) in the block chain to the account address of the user B in the block chain, after the digital currency is moved to the account of the user B, the corresponding amount of intermediate currency is subtracted from the account of the user B.

9-12. (canceled)

13. The digital currency settlement system according to claim 1, wherein the network server (4) stores relevant information associated with user information (S), and generates matching information according to the user information (S),
the payment device (1) stores at least two fields of information, wherein a first field information comprises the account address (D1) of the user A in the digital currency block chain (3), a second field information comprises the user information (S),
the settlement terminal (6) acquires at least two fields of information from the payment device (1),
decomposes the information to obtain the first field information and the second field information,
and sends the user information (S) in the second field to the network server (4), obtains the matching information sent by the network server (4), verifies user identity based on the matching information, and generates the transaction for the user who has passed identity verification.

14. The digital currency settlement system according to claim 13, wherein the matching information of the network server (4) comprises a password,
the settlement terminal 6 judges whether the password input by the user is correct according to the password in the matching information to verify the user identity.

15. The digital currency settlement system according to claim 13, wherein the matching information of the network server (4) comprises a mobile phone number,
the settlement terminal (6) sends a verification code to the mobile phone number according to the mobile phone number in the matching information, and judges whether the verification code input by the user is correct to verify the user identity.

16. The digital currency settlement system according to claim 13, wherein the matching information of the network server (4) comprises time or/and position information,
the settlement terminal (6) verifies whether the transaction is carried out at a specified time or/and a specified position according to the time or/and position of the matching information and the current time, or/and the current position of the payment device (1).

17. The digital currency settlement system according to claim 11, wherein the first field comprises website information, and the account address (D1) of the user A is comprised in the website information.

18-20. (canceled)

21. A digital currency settlement method, comprising the following steps:
reading step: the settlement terminal (6) reads at least the account address of the user A in the digital currency block chain (3) from the payment device (1);
information identifying and transaction generation step: the settlement terminal (6) identifies the read information and generates a transaction according to the identified information, and the transaction is sent to the management center (5) through the network server (2), the transaction information comprises account address of the user A in digital currency block chain read from the payment device (1), account address of the user B receiving payment in digital currency block chain, amount y of digital currency moved from account address of the user A in digital currency block chain to account address of the user B in digital currency block chain;
intermediate currency conversion step: the management center (5) stores at least the accounts of the user A and user B and the account addresses of the management center (5) in the block chain, wherein the accounts of the user A and user B are used for transferring intermediate currency, and a certain amount of intermediate currency is pre-stored in the account of the user A, and the management center (5) converts the amount of digital currency y in the transaction information into a corresponding amount of intermediate currency Y0 according to the received transaction;
intermediate currency moving step: the management center (5) moves the corresponding amount Y0 of intermediate currency from the account of the user A to the account of the user B;
counting: the management center (5) counts the total amount y of intermediate currency in the account of the user B after a certain time or after the intermediate currency transferred to the account of the user B reach a certain amount,
digital currency conversion step: the management center (5) converts the total amount of intermediate currency into a corresponding amount Z of digital currency;
transaction generating and sending step: the management center (5) generates a transaction for moving digital currency to the user B, sends the transaction to the digital currency block chain (3), and records the transaction as a block at the end of the block chain after confirmation by the nodes (1 . . . n), the transaction information comprises the account address of the management center (5) in the block chain, the account address of the user B in the block chain, and the amount Z of digital currency moved from the account address of the management center (5) in the block chain to the account address of the user B in the block chain;
account processing step: after the management center (5) successfully moves the digital currency, the management center (5) subtracts the corresponding amount of intermediate currency from the account of the user B.

22. The digital currency settlement method according to claim 21, wherein
the network server (4) stores relevant information associated with the user information (S), and generates matching information according to the user information (S),
the payment device (1) stores at least two fields of information, the first field information comprises the account address (D1) of the user A in the digital currency block chain (3), and the second field information comprises user information (S),
in the information identifying and transaction generation step, before generating the transaction, the identified second field information is sent to the network server (4), the network server (4) generates matching information, verifies user identity according to the matching information, and generates a transaction for the user who passes identity verification.

23. The digital currency settlement method according to claim 21, wherein the matching information sent by the network server (4) comprises a password,
In the information identifying and transaction generation step, whether the password in the matching information is consistent with the password input by the user is verified to judge whether the user is the user A.

24. (canceled)

25. The digital currency settlement method according to claim 22, wherein the matching information sent by the network server (4) comprises time or/and position information,
in the information identifying and transaction generation step, according to the time in the matching information and the current time, whether the transaction time is within a specified time interval or/and the transaction position is within the specified position is verified.

26. A digital currency payment device, wherein the payment device (1) comprises an information carrier (11) and payment information (12) stored on the information carrier, the payment information comprises at least two fields of information, wherein a first field information comprises an account address (D1) of user A in a digital currency block chain (3), and a second field information comprises user information (S), the user information (S) is subordinate to the account address (D1), and is used for verifying the user.

27. The payment device according to claim 26, wherein the payment information (12) is printed or displayed on the information carrier in the form of a graphic code, and the graphic code comprises at least a QR code or a bar code, which is read by an optical identifying device.

28. (canceled)

29. The payment device according to claim 26, wherein the payment device (1) comprises a storage module (13), a payment information generating module (14), and a display module (16), the storage module (13) stores a key and the user information (S), and the payment information generating module (14) generates the account address (D1) by using the key, and generates the first field information comprising the account address (D1) and the second field information comprising the user information (S), and the display module (16) displays and updates the payment information in the form of a graphic code or electronic signal.
